(19) United States
(12) Patent Application Publication
(10) Pub. No.: US 2011/0225109 A1
(43) Pub. Date: Sep. 15, 2011

(54) Hardware acceleration of DNA codeword searching and fitness determination

(76) Inventors: Daniel J. Burns, Rome, NY (US); Qinru Qiu, Vestal, NY (US); Qing Wu, Vestal, NY (US); Prakash Mukre, Newport Beach, CA (US)

(21) Appl. No.: 13/068,911

(22) Filed: May 19, 2011

Related U.S. Application Data
(62) Division of application No. 12/378,261, filed on Feb. 12, 2009.
(60) Provisional application No. 61/123,564, filed on Mar. 31, 2008.

(51) Int. Cl. G06N 3/12

(52) U.S. Cl. 706/13

(57) ABSTRACT

An apparatus for a hybrid architecture that consists of a general purpose microprocessor and a hardware accelerator for accelerating the discovery of DNA reverse complement, edit distance codes. Two embodiments are implemented and evaluated, including a code generator that uses a genetic algorithm (GA) to produce nearly locally optimal codes in a few minutes, and a code extender that uses exhaustive search to produce locally optimum codes in about 1.5 hours for the case of length 16 codes. Experimental results demonstrate that the GA embodiment can find ˜99% of the words in locally optimum libraries, and that the hybrid architecture embodiment provides more than 1000 times speed-up compared to a software only implementation.

### PRIORITY CLAIM UNDER 35 U.S.C. §119(e)

This patent application claims the priority benefit of the filing date of a provisional application, Ser. No. 61/123,564, filed in the United States Patent and Trademark Office on Mar. 31, 2008.

### CROSS-REFERENCE TO RELATED APPLICATIONS

The present application is a divisional application of and claims priority from related, co-pending, and commonly assigned U.S. patent application Ser. No. 12/378,261 filed on Feb. 12, 2009, entitled “Hardware Acceleration of DNA Codeword Searching” also by Daniel J. Burns, Qinru Qiu, QingWu, and Prakash Mukre. Accordingly, U.S. patent application Ser. No. 12/378,261 is herein incorporated by reference.

### STATEMENT OF GOVERNMENT INTEREST

The invention described herein may be manufactured and used by or for the Government of the United States for governmental purposes without the payment of any royalty thereon.

### BACKGROUND OF THE INVENTION

The DNA molecule is now used in many areas far beyond its traditional function. The first DNA-based computation was proposed by Adleman [1]. It demonstrates the effectiveness of using DNA to solve hard combinatorial problems. DNA molecules have

One of the major concerns of DNA computing is reliability. In DNA computing, information is encoded as DNA strands. Each DNA strand is composed of short codewords. DNA computing is based on the hybridization process, which allows short single-stranded DNA sequences (i.e. oligonucleotides) to self-assemble to form long DNA molecules. The reliability of the computing is determined by whether the oligonuleotides hybridize in a predetermined way. The key to success in DNA computing is the availability of a large collection of DNA codeword Watson-Crick pairs that do not hybridize well across pairs. Another use of DNA codeword libraries is for tag/anti-tag libraries that provide for spatially localized binding between tagged probe DNA fragments and antitagged complimentary target DNA fragments in microarray chips used to analyze genomic content. Various quality metrics have been proposed to guide the construction process [1]-[5]. The computation of these metrics dominates the run time of the code building process. While metrics based on the Gibbs energy and nearest neighbor thermodynamics and consideration of secondary structure formation give accurate measurement of hybridization, they are computationally costly, motivating the use of simplified metrics. One such metric is the Levenshtein distance, or the so-called deletion-correcting or edit distance, which has been used to construct DNA codes [6].

Regardless of the quality metric used, composing DNA codes is NP-hard because the number of potential codewords that must be searched increases exponentially with the length of the DNA codewords. Exhaustive checking is generally impractical for words of length greater than about 12 base pairs. Various algorithms have been proposed for building DNA codes, including the genetic algorithm (GA) [7], Markov processes [8], and Stochastic methods [9]. Recent work [10] has shown that a hybrid GA blended with Conway's lexicode algorithm [11] [12] achieves better performance than either one alone in terms of generating useful codes quickly.

Search methods for DNA codes are extremely time consuming, and this has limited research on DNA codeword design, especially for codes of length greater than about 12-14 bases. Theory is lacking to provide tight upper bounds on the size of codeword sets, and the best known bounds are base on experiments. For example, the largest known reverse complement edit distance DNA codeword library (length 16, edit distance 10) consist of 132 pairs, composing such codes can take several days on a cluster of 10 G5 processors. What is needed is a method and apparatus to accelerate this process.

### OBJECTS AND SUMMARY OF THE INVENTION

The present invention provides an apparatus to speed-up the composition of reverse complement, edit distance, DNA codes of length 16, using a modified genetic algorithm that uses a locally exhaustive, mutation-only heuristic tuned for speed. Alternate embodiments of the present invention address extensions to metrics involving nearest neighbor thermodynamics, a more general GA, and DNA codewords of length 32.

More specifically, the present invention provides a novel accelerator for DNA codeword composition that incorporates a hardware GA, hardware edit distance calculation, and hardware exhaustive search. Hardware exhaustive search extends an initial codeword library by doing a final scan across the entire universe of possible codewords, yielding a locally optimum code. The invention's architecture consists of a host PC, a hardware accelerator implemented in reconfigurable logic on afield programmable gate array (FPGA) and a software program running in a host PC that controls and communicates with the hardware accelerator. The characteristics of the present invention's architecture are as follows:

1. High performance. The present invention utilizes programmable logic devices to enable pipelined and massively parallel processing of the data. Compared with software-only approaches, the present invention's novel architecture can provide more than 1000× speed-up. For example, for length 16 code words, instead of 52 days using software, it only takes 1.5 hours using hardware to scan the entire codeword space and to find all additional words that must be added to produce a locally optimum code.

2. High flexibility. The present invention's hardware accelerator can be configured by software program, and it can be run on a workstation PC equipped with an FPGA board, or on a notebook PC equipped with a PCMCIA FPGA card.

3. User friendly. The present invention's hardware accelerator is transparent to the user. Access to and control of the FPGA is accomplished by memory reads and writes based on a set of given protocols.

The DNA molecule is a nucleic acid. It consists of two oligonucleotide sequences. Each sequence consists of a sugarphosphate backbone and a set of nucleotides (also called bases) connecting with the backbone. The oligonucleotide sequence is oriented. One end of the sequence is denoted as 3′ and the other as 5′. Only strands of opposite orientation can form stable duplex.

There are four types of bases: Adenine, Thymine, Cytosine, and Guanine. They are denoted briefly as A, T, C, and G respectively. Each base can pair up with only one particular base through hydrogen bonds: A+T, T+A, C+G and G+C. Sometimes we say that A and T are complementary to each other while C and G are complementary to each other. A Watson-Crick complement of a DNA sequence is another DNA sequence which replaces all the A with T or vice versa and replaces all the T with A or vice versa, and also switches the 5′ and 3′ ends. A DNA sequence binds most stably with its Watson-Crick complement. The stability of the binding is determined by the free energy of the hydrogen bonds.

The calculation of the free energy involves many considerations. The present invention employs the first order effect, and uses the number of Watson-Crick pairs between two DNA sequences to represent their bonding strength. Such approximation is widely adopted by the research works in DNA codeword design [6] [12]. Furthermore, the DNA sequences of length 10 or greater are usually considered to be flexible [6]. Therefore, the binding strength of two DNA strands is measured by the length of the longest complementary subsequence (not necessarily contiguous) of one strand and the reverse of the other. For example, FIG. 1 shows two DNA strands that bind with 5 Watson-Crick pairs. The longest complementary sequence between two flexible DNA strands, A and B, is the same as the longest common subsequence (LCS) between A and B [6].

The present invention considers each DNA codeword as a sequence of length n in which each symbol is an element of an alphabet of 4 elements. The longest common subsequence between DNA strands A and B is denoted as LCS(A, B). The present invention searches for a set of DNA codeword pairs S, where S consists of a set of DNA strands of length n and their reverse complement strands e.g. {(s1, s1′), (s2, s2′), . . . }, where (s1, s1′) denotes a strand and its Watson-Crick complement. The methodology can be formulated as the following constrained optimization problem:

max |S| (1)

s.t. LCS(s1, s1′)≦σ, ∀s1εS, (2)

LCS(s1, s2)≦σ, ∀s1s2εS (3)

LCS(s1, s2′)≦σ, ∀s1, s2εS, (4)

where σ is a predefined threshold. Equation (1) maximizes the size of the DNA codeword library. The first constraint specifies that a DNA codeword in the library cannot bind with itself. The second and the third constraints specify that a DNA codeword in the library cannot bind with another library word or its Watson-Crick complement. Both of these two constraints must be satisfied because a DNA strand always occurs with its Watson-Crick complement. We note that other checks are equivalent to the checks mentioned here, for example, for LCS(s1,s2) we could substitute LCS(s1′, s2′), and for LCS(s1,s2′) we could substitute LCS(s1′,s2).

A genetic algorithm (GA) is a stochastic search technique based on the mechanism of natural selection and recombination. Solutions, which are also called individuals, are evolved from generation to generation, with selection, mating, and mutation operators that provide an effective combination of exploration of the global search space. The Island multideme GA is a widely used parallel GA model in which the population is divided into several sub-populations and distributed on different processors. Each sub-population evolves independently for a few generations, before one or more of the best individuals of the sub-populations migrate across processors.

Although it is effective for many other optimization problems, it has been observed that selection and mating slowed the evolution of beneficial fitnesses in the population. Therefore, the present invention employs a modified GA without mating. The approach is similar to Tulpan's [9], except that the present invention starts with an empty library, and a separate GA population of next word candidate individuals with random base content. Each individual in the population is a DNA codeword encoded as a binary string with length 2n, where n is the length of the codeword in bases. The four bases (A, T, C, G) are encoded as (00, 01, 11, 10). Each DNA strand of length 16 can be represented as a 32 bit integer.

Given a codeword library S, the fitness of each individual d reflects how well the corresponding codeword fits into the current codeword library. It is a weighted sum of two values (reject_num, max_match). The reject_num is the number of codewords in the library which satisfies the condition

LCS(s, d)>σ or LCS(s, d′)>σ, ∀sεS (5)

and the max_match can be calculated as:

max(|LCS(d, d′)−σ|,|LCS(s, d)−σ|, |LCS(s, d′)−σ|, ∀sεS (6).

The codeword with lower fitness fits better in the library, and only codewords with reject_num=0 will be added into the library.

Equations (2)-(4) indicate that a valid library word must have reject_num equal to 0. It is observed that adding a codeword with reject_num=0 and |max_match−σ|>0 into the library will restrict the future growth of the library. Such codewords bind very weakly with other library words, but they are too far apart in the search space and interfere with closest packing. To maximize the library size, only those codewords that are “just good enough” should be selected. To ensure this, the present invention changes the calculation of reject_num to the number of codewords in the library which satisfies the condition

LCS(s, d)!=σ or LCS(s, d′)!=σ, ∀sεS (7)

Therefore, only codewords with reject_num=0 and max_match=0 will be added into the library.

A traditional GA mutation function might randomly pick an individual in the population, randomly pick a pair of bits in the individual representing one of its 16 bases, and randomly change the base to one of the 3 other bases in the set of 4 possible bases. In the present invention, however, an individual is randomly selected, but then all of the 48 possible base changes are exhaustively checked. This modification is an attempt to speed beneficial evolution of the population by minimizing the overhead that would be associated with randomly picking this individual again and again in order to test those mutations. The present invention also specifies that if none of the 48 mutations were beneficial, either one of them is selected at random (mode 1), or the individual is replaced with a new random individual (mode 2). It is thought that mode 1 may enable better local search by allowing the individual to remain in the population and possibly experience subsequent (multiple) mutations, while mode 2 may enable wider global search. FIG. 2 gives the pseudo code for the modified mutation function, for the case of mutation mode 1.

When an individual in the population achieves a fitness of 0, it is added to the set of good codewords, and the selected individual in the population is replaced by a new random individual. The GA is allowed to run until one of three termination criteria is satisfied: the number of codewords in the set is as large as desired; the algorithm has run for a specified maximum number of generations; or the algorithm has run for a specified maximum amount of time. The codeword values, the elapsed time at which they are each found during a run are stored in memory and saved to a disk file at the end of a run. The present invention also calculates and stores the average time at which the ith words are found across multiple runs to statistically assess average performance.

The most time consuming part of the present invention's GA process is in calculating the fitness value for each individual. Performance profiling of our software GA version showed that >98% of the computing time was spent calculating the LCS distance between DNA strands. The LCS distance is calculated using dynamic programming. FIG. 3 gives the pseudo code of the process. The intermediate results are stored in an n×n matrix, where n is the length of the DNA codeword in bases. The calculation starts at the top left corner of the matrix and the final result is the value calculated in the cell located at the bottom right corner. For DNA codewords with length 16, at least 256 operations are needed to obtain the final result. Therefore, the throughput of the software based LCS calculation is less than 1/n².

The process can also be implemented using a 2D systolic array. The systolic array is an n×n matrix of cells. FIG. 4a shows the structure of each cell in the matrix. Each cell consists of three registers: A, B and ans. For the cell at location (i,j), the registers A and B are used to store the ith nucleotide of one DNA codeword (north word) and the jth nucleotide of the other DNA codeword (west word) respectively. The register ans is used to store the intermediate result of the dynamic programming calculation. Each cell has five inputs. Two of the inputs connect to register A and register B of the upper and left neighbor cells. The other three inputs connect to the ans registers of the upper, left and diagonal neighbor cells. In the present hardware version it takes two clock cycles for a cell to update its answer. In the first clock period, input registers A and B are updated, and in the second clock period, the cell output answer is calculated and the register ans is updated. In order to prevent ripple through operation, the cells in the even columns and odd rows are synchronous to each other and operate as described above, but in the cells in the odd columns and even rows (which are also synchronous) the two operations are reversed, i.e. the ans output is calculated in the first clock period and the A and B inputs are updated in the second clock period.

The overall architecture of the 2D systolic array is shown in FIG. 4b. The marked cells calculate their answers in the same clock cycle while the unmarked cells calculate their answers in the next clock cycle. In this way, the results propagate through the array diagonally. The final result is given by the ans register of the cell at the right bottom corner of the 2D array. It is evident that after a latency period that is required to fill the pipeline, the throughput of the systolic array is ½, i.e. 1 output result per 2 clock periods. When n increases, the throughput remains the same while the hardware cost increases, as long as the reconfigurable hardware chip has sufficient resources to implement a full n×n array of cells. Another detail is that the systolic array must be fed by an array of registers that delay the entry of the bases on the right of the North word and at the bottom of the West word. In effect, this synchronizes the presentation of those parts of the operand words with the diagonal waves of intermediate calculations in the cells that proceed from the upper left corner down and to the right through the array. It should be noted that a version of this array for words of length 32 vs. 16 would use 4× the resources, have twice the latency, but potentially would clock and provide answers at the same rate. Such an experimental prototype of the present invention has been built, and it demonstrated an acceleration over software of 30,000×.

It is therefore an object of the present invention to provide an apparatus for accelerating the discovery of DNA reverse complement codes.

A further object of the present invention is to provide an apparatus for the faster generation of nearly locally optimum DNA codewords using a computer, a hardware accelerator, and a software program to implement a genetic algorithm.

Yet another object of the present invention is to provide an apparatus for the faster generation of locally optimum DNA codewords using a computer, a software program, and a hardware accelerator to implement an exhaustive search.

A particular object of the present invention is to provide an apparatus for the faster generation of both nearly locally optimum and locally optimum DNA codewords using a hardware accelerator based upon field programmable gate arrays.

Briefly stated, the present invention provides an apparatus for a hybrid architecture that consists of a general purpose microprocessor, hardware accelerator, and software code for accelerating the discovery of DNA reverse complement, edit distance codes. Two embodiments are implemented and have been evaluated, including (1) a code generator that uses a genetic algorithm (GA) to produce nearly locally optimal codes in a few minutes, and (2) a code extender that uses exhaustive search to produce locally optimum codes in about 1.5 hours for the case of length 16 codes. Experimental results demonstrate that the GA embodiment alone (1) actually finds ˜99% of the words in locally optimum libraries produced by taking the libraries produced by (1) and extending them by use of (2), and that the hybrid architecture embodiments (1 and 2) provide more than 1000× speed-up compared to a software only implementation.

To the accomplishment of the foregoing and related ends, the present invention, then, comprises the features hereinafter fully described and particularly pointed out in the claims. The following description and the annexed figures set forth in detail certain illustrative embodiments of the invention. These embodiments are indicative, however, of but a few of the various ways in which the principles of the invention may be employed. Other objects, advantages and novel features of the present invention will become apparent from the following detailed description of the invention when considered in conjunction with the figures.

### REFERENCES

[1] L. M. Adleman, “Molecular Computation of Solutions to Combinatorial Problems,” Science, vol. 266, pp. 1021-1024, November 1994.

[2] A. Brenneman and A. Condon, “Strand Design for Biomolecular Computation”, Theoretical Computer Science, vol. 287, pp. 39-58, 2002.

[3] S.-Y. Shin, I.-H. Lee, D. Kim, and B.-T. Zhang, Multiobjective Evolutionary Optimization of DNA Sequences for Reliable DNA Computing”, IEEE Transactions on Evolutionary Computation, vol. 9(20), pp. 143-158, 2005.

[4] F. Tanaka, A. Kameda, M. Yamamoto, and A. Ohuchi, Design of Nucleic Acid Sequences for DNA Computing based on a Thermodynamic Approach, Nucleic Acids Research, 33(3), pp. 903-911, 2005.

[5] J. Santalucia, “A Unified View of polymer, dumbbell, and oligonucleotide DNA nearest neighbor thermodynamics”, Proc. Natl. Acad. Sci., Biochemistry, pp. 1460-1465, February 1998.

[6] A. D'yachkov, P. L. Erdös, A. Macula, V. Rykov, D. Torney, C-S. Tung, P. Vilenkin and S. White, “Exordium for DNA Codes,” Journal of Combinatorial Optimization, vol. 7, no. 4, pp. 369-379, 2003.

[7] R. Deaton, M. Garzon, R. C. Murphy, J. A. Rose, D. R. Franceschetti, and S. E. Jr. Stevens, “Genetic search of reliable encodings for DNA-based computation,” Proceedings of the First Annual Conference on Genetic Programming, pp. 9-15, July 1996.

[8] Bishop, M., Macula, A., Pogozelski, W., and Rykov, V., “DNA Codeword Library Design”, Proc. Foundations of Nanoscience—Self Assembled Architectures and Devices, (FNANO), April 2005.

[9] Tulpan, D. C., Hoos, H., Condon, A., “Stochastic Local Search Algorithms for DNA Word Design”, Eighth International Meeting on DNA Based Computers(DNA8), June 2002.

[10] S. Houghten, D. Ashlock and J. Lennarz, “Bounds on Optimal Edit Metric Codes”, Brock University Technical Report #CS-05-07, July 2005.

[11] Milenkovic and N. Kashyap, “On the Design of Codes for DNA Computing,” Lecture Notes in Computer Science, pp. 100-119, Springer Verlag, Berlin-Heidelberg, 2006.

[12] R. Brualdi, and V. Pless, “Greedy Codes,” Journal of Combinatorial Theory Series A, vol. 64, pp. 10-30, 1993.

[13] http://www.xilinx.com/

[14] http://www.annapmicro.com/

[15] D. Burns, K. May, T. Renz, and V. Ross, “Spiraling in on Speed-Ups of Genetic Algorithm Solvers for Coupled Non-Linear ODE System Parameterization and DNA Code Word Library Synthesis,” MAPLD International Conference, 2005.

### BRIEF DESCRIPTION OF THE DRAWINGS

FIG. 1 depicts binding between DNA strands.

FIG. 2 depicts the computer implementable mutation heuristic steps the present invention employs to improve the fitness of candidate DNA codewords.

FIG. 3 depicts the computer implementable steps the present invention employs to determine the fitness of a DNA codeword.

FIG. 4 depicts the systolic array the present invention employs to compute the fitness of a DNA codeword.

FIG. 5 depicts the system architecture of the present invention the interconnection of a computer, hardware accelerator and bus interface.

FIG. 6a depicts the control and data flow state diagram of the process performed by the hardware accelerator.

FIG. 6b depicts the scheduling of operations state diagram of the process performed by the hardware accelerator.

FIG. 7 depicts a table of input and output buffer operations.

FIG. 8 depicts a flow diagram of the communication between the hardware accelerator and host computer associated with the process for the discovery and reporting of a new code word.

FIG. 9 depicts the architecture for an enhancement of the present invention employing a plurality of hardware accelerator modules.

FIG. 10 depicts the state diagram for the arbiter employed in the enhanced embodiment of the present invention.

FIG. 11 depicts the characteristics of the reconfigurable logic and on-chip memory devices used to date to implement the present invention.

FIG. 12 depicts the performance comparison between a prior art software-only based DNA codeword search process and the present invention's hardware accelerator-based DNA codeword search process in terms of the time vs. number of DNA codewords found.

FIG. 13 depicts the performance comparison between a prior art software-only based DNA codeword search process and the present invention's hardware accelerator-based DNA codeword search process with extension using hardware exhaustive search in terms of time vs. the number of DNA codewords found.

FIG. 14 depicts the size of local optimal DNA codeword libraries built by the present invention within a 300 sec. initial GA search followed by a 1.5 hr exhaustive search.

FIG. 15 depicts the sizes of a multiplicity of locally optimum DNA codeword libraries built by the present invention within a 600 second exhaustive search, in terms of words found by GA and words found by exhaustive search.

FIG. 16 depicts a histogram of the number of DNA codewords added by exhaustive search for the runs depicted in FIG. 15.

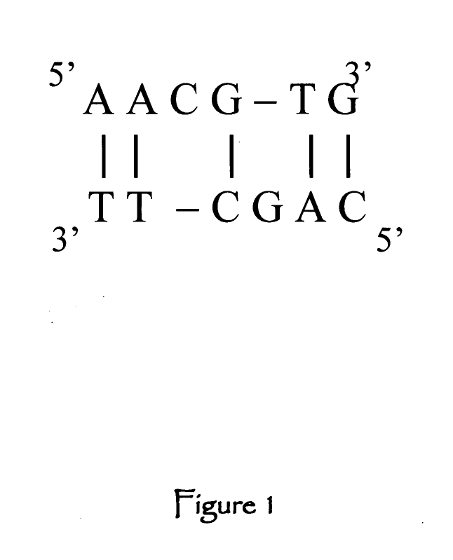

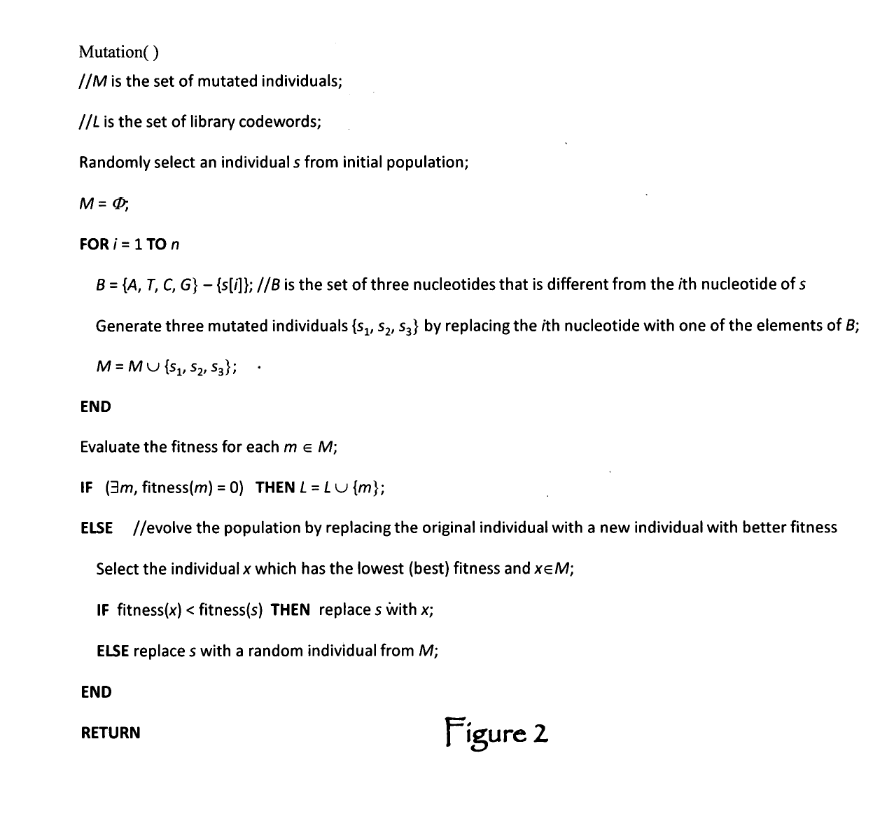

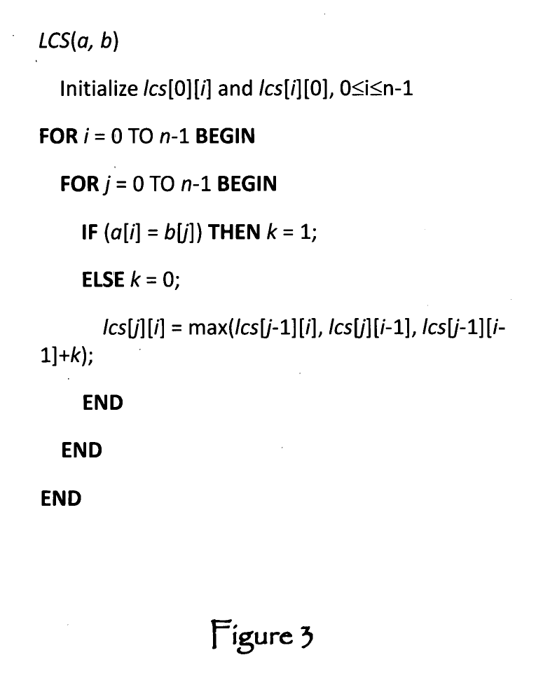

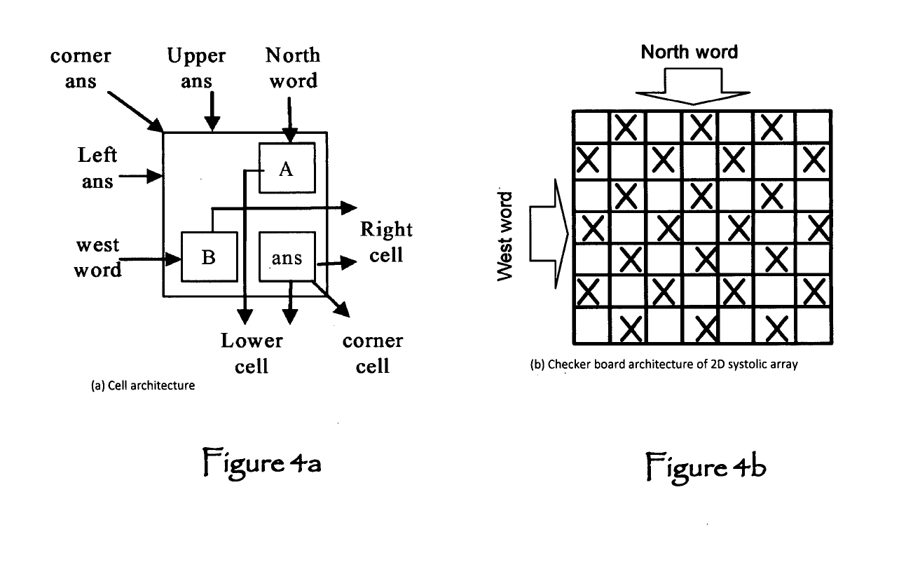

### DETAILED DESCRIPTION OF THE GENERALIZED EMBODIMENT

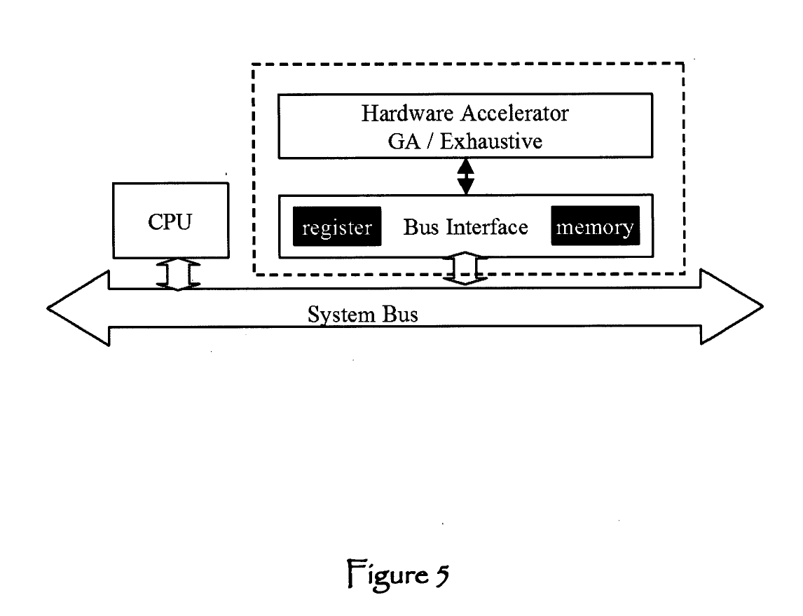

The present invention consists of a host CPU, a hardware accelerator and a software program running on the host CPU. The host CPU and the hardware accelerator are connected via the system bus. FIG. 5 shows the architecture of the present invention. In order to increase the portability of the design, the hardware portion is divided into two modules: the bus interface and the hardware accelerator core. The bus interface module connects to the bus as a slave. It has a set of command registers and an information exchange memory, which can be accessed by both CPU and the hardware accelerator. To implement the system on a system with a different bus architecture a new bus interface might be required, but the hardware core would remain the same.

### Hardware Acceleration for GA Based Codeword Search

In the present invention, a two-level method is adopted to control the hardware accelerator. At the top level, the operations of the hardware accelerator are categorized into 7 states: {idle, init, check_pop, mutation, check_mutate, update_pop, update_lib}. In the init state, the hardware accelerator generates a random initial population, and sets up either an empty initial library, or reads an initial partial library from a disk file. In the mutate state, the hardware accelerator produces a population of 47 mutated individuals based on a chosen individual. The hardware accelerator calculates the fitness for all the individuals in the initial population, and in the mutated population, in the “check_pop” and “check_mutate” states, respectively. In the “update_lib” state, the hardware accelerator writes the newly discovered acceptable codewords into the library. In the “update_pop” state, the hardware accelerator writes the best (or a randomly chosen) mutated individual back to the working population.

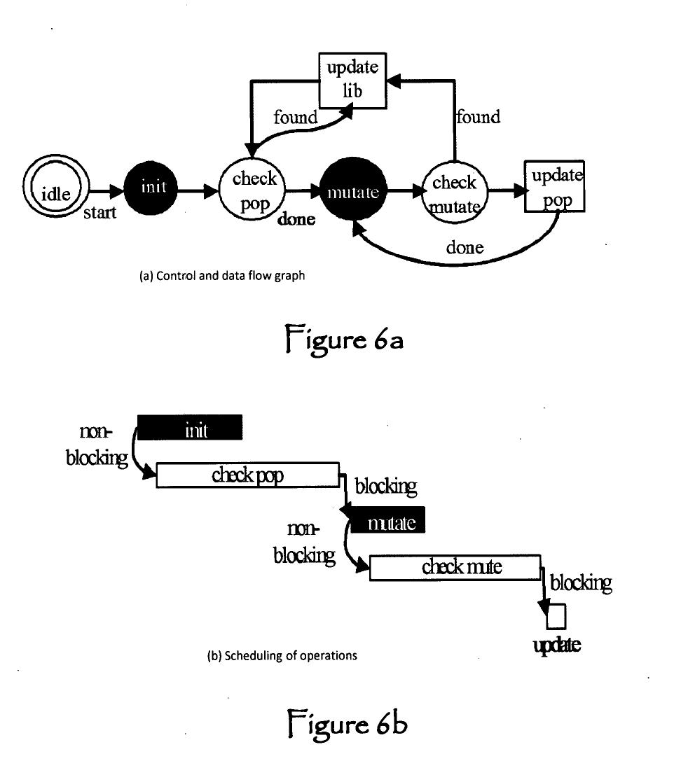

Each state corresponds to an operation in the present invention's GA process. FIG. 6a shows the control and data flow graph (CDFG) of the process based on this state division. The “update_lib” and “update_pop” operations are one cycle operations because they only perform a memory write. All the other operations are multi-cycle operations, which again can be divided into several sub-states. When the top level state machine enters the corresponding state of a multi-cycle operation, the second level state machine is triggered.

In the present invention, an operation is a blocking operation if its successors in the CDFG cannot start until this operation is done. Similarly, an operation is called non-blocking operation if its successors can start right after this operation started. The “init” and “mutation” operations are both non-blocking operations. While the hardware accelerator is generating the initial population and the mutated population, it is at the same time checking the fitness of the generated individual. The “check_pop” and “check_mutate” operations are blocking operations. Their successors, i.e. “mutate” and “update_pop”, cannot start until they have been finished. FIG. 6b shows the scheduling of the operations.

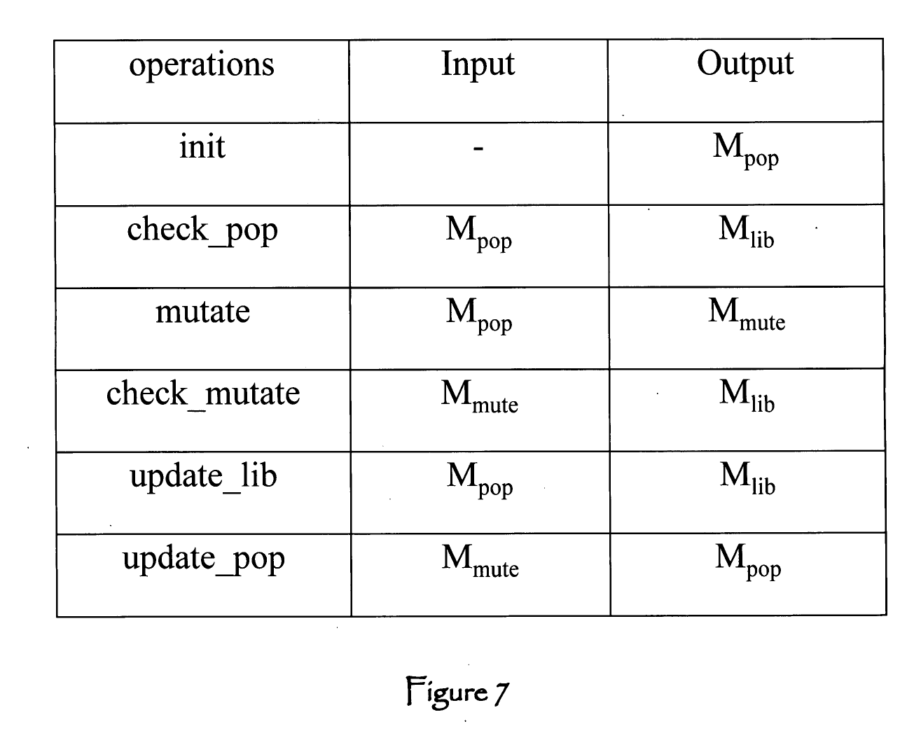

A buffer is needed to pass the results of one operation to its successor. In particular, a first-in-first-out (FIFO) storage should be used as the output buffer of a non-blocking operation. However, the implementation of the FIFO is relatively easy in this design because the non-blocking operations are always faster than their successors. Therefore, it is not necessary to check the FIFO underflow condition. The present invention employs a dual port memory as the output buffer for the design. Three memory blocks are used: Initial Population Memory (Mpop), Mutated Population Memory (Mmutate) and CodeWord Library Memory (Mlib). The input and output buffer of different operations are given in FIG. 7.

### Hardware Software Interface

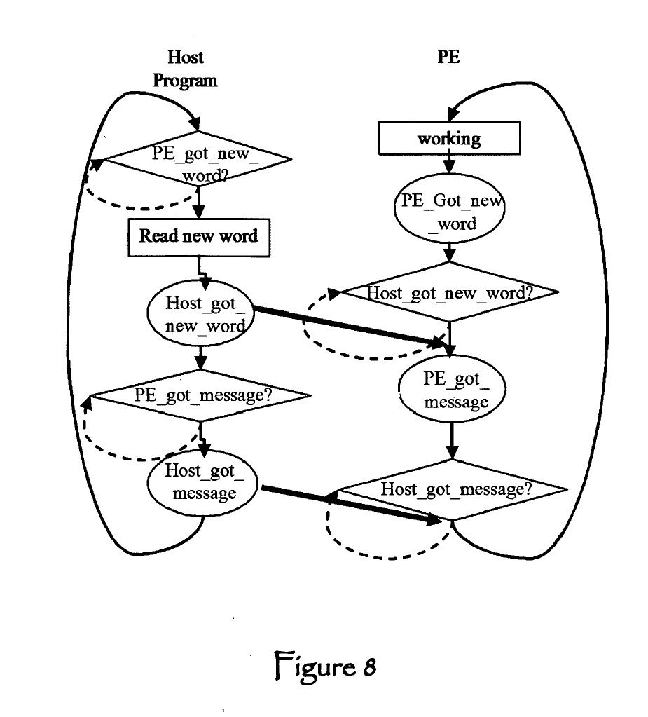

In the present invention the hardware accelerator and the host CPU program run asynchronously. A four-way handshaking protocol is used to synchronize the communication between hardware and software, as shown in FIG. 8. For example, when the hardware accelerator finds a new codeword, it writes the word to a particular memory location, and then raises the “PE_got_new_word” flag to the host program. After detecting this flag, the host program reads the new codeword, and then raises the host_got_new_word” flag. After detecting this flag, the hardware accelerator then clears the “PE_got_new_word” flag and acknowledges the host program by raising the

“PE_got_message” flag.

After detecting this flag, the host program then clears the “host_got_new_word” flag and acknowledges the hardware accelerator by raising the “host_got_message” flag, and continues. After detecting this flag, the hardware accelerator then clears the “PE_got_message” flag and continues. After the handshaking, the host program and the hardware accelerator work asynchronously until the host or hardware accelerator raises another message flag.

### Parallel GA

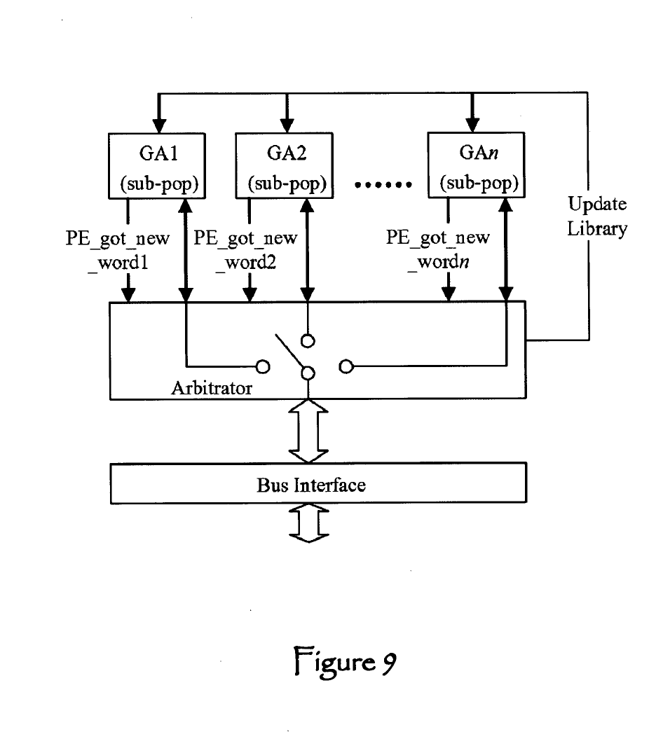

The hardware accelerator employed in the present invention as discussed above uses approximately 12,263 LUTs (look-up-tables), which is only about 42% of the programmable resources in a Xilinx Virtex II 3000 FPGA, or about 16% of the programmable resources in a Xilinx XC2VP70 FPGA. Therefore, the present invention may capitalize on a further speed-up enhancement by implementing multiple parallel hardware accelerators to process separate GA populations to evolve good code words for the same library on a single FPGA, as shown in FIG. 9.

The speed up apparatus comprises n hardware accelerator modules, which are denoted as GA1˜GAn, an arbitrator and a bus interface. The value of n is determined by the size of the FPGA. For example, n is 2 for the Virtex II 3000 FPGA and n is 5 for the XC2VP70. Each GA module implements the above mentioned genetic algorithm to search for the DNA codeword. They are independent of each other. The populations in different GA modules are initialized using different random seeds.

All the GA modules are connected to the bus interface through an arbiter. When a GA module finds a new codeword, it raises the “PE_got_new_word” flag and requests to be connected to the bus interface to communicate with the host. The arbiter broadcasts the new codeword to all other GA modules and raises the “update_library” flag. GA modules that receive the “update_library” request must terminate the current operation and go to “update_lib” state. If multiple GA modules raise the “PE_got_new_word” flag simultaneously, the arbiter must select one of them and invalidate the others. The decision is based on a fixed priority. The arbiter also connects the selected GA module that has found a new codeword with the bus interface to communicate the new word to the host.

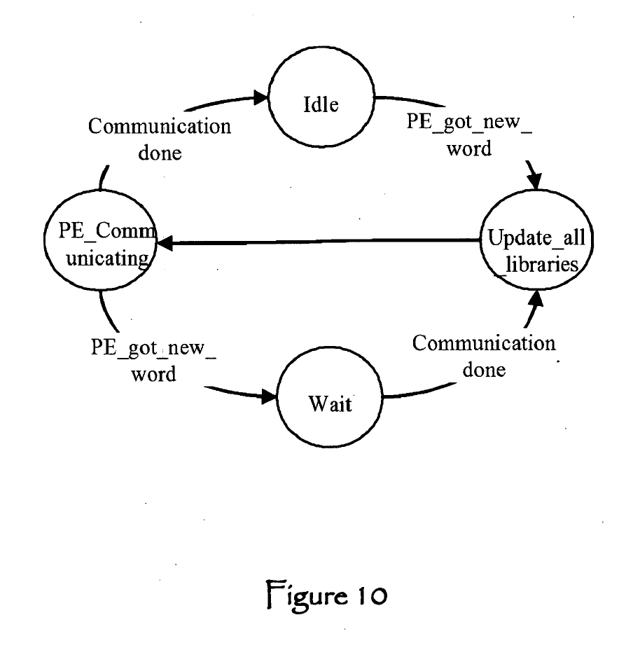

If another GA module simultaneously finds a new word, it must wait till the end of the current host-PE communication procedure before it can be connected to the bus interface. FIG. 10 shows the state machine controller of the arbiter. The arbiter will be in the idle state after reset. When one of the GA modules raises the “PE_got_new_word” flag, the arbiter will go to the “update_all_libraries” state during which the arbiter raises the “update_library” flag. In the next clock period, it goes into the “PE_communicating” state during which the arbiter connects the GA module to the bus interface.

If the communication finishes before another GA module finds a new word, then the arbier goes back to the idle state. Otherwise, it first goes to the wait state. After the communication is done, it goes to the “update_all_libraries” state and repeats the previous steps.

The present invention also includes provisions for (optionally, and periodically) moving some of the best individuals from the population being processed by each GA module to another GA module. For example, after every epoch of perhaps 40 generations, a small number of individuals (perhaps 5) may be passed around a ring configuration of GA modules. The feature is intended to potentially improve the average fitness of a GA module's population that has for some reason not evolved fitnesses as good as the other GA module populations.

This distributed multi-population GA processing method employed by the present invention achieves approximately linear codeword discovery speedup vs. the number of GA modules n.

### Hardware Acceleration for Exhaustive Search

The effectiveness of the stochastic search begins to decrease when the search space increases and the solution space decreases. Stated another way, as codewords are added to the library, the time required to find a new codeword increases exponentially. Furthermore, using stochastic search, it is not possible to determine whether still another new codeword can be added to the library, so it is difficult to determine how long to let the algorithm run. To avoid this problem, the present invention employs exhaustive search, i.e. to check every codeword in the universe of all possible codewords. The complexity of exhaustive searching increases linearly with the number of codewords already in the library, and exponentially with the length of the codewords due to the nature of the LCS calculation. As the name suggests, for a given initial library, the exhaustive search must scan the entire codeword space and find all remaining additional valid codewords that satisfy constraint equations (2)-(4). For DNA codewords of length 16, and for an initial library of 100 codewords, exhaustive search would take 52 days on a 2.0 GHz Intel Xeon processor running a software fitness checker at 10 microseconds per check.

With small modification to the original hardware GA guided discovery algorithm, the present invention can implement exhaustive DNA codeword search using hardware. The hardware accelerator for exhaustive codeword search consists of a memory used to store the codeword library, a 32 bit counter cycled from 0 to its maximum value to represent the potential new word, and two systolic array fitness checkers. For each codeword x, the calculation of LCS(x, s) and LCS(x, s′), where sεS, are performed simultaneously by the two fitness checkers. At 100 Mhz clock frequency, the hardware accelerator takes about 1.5 hours to scan the entire ˜4.3 billion codeword space for codewords of length 16, which is over 800 times faster than the workstation PC software only case. At the completion of exhaustive search a codeword set is known to be locally optimum, in the sense that given the series of random numbers used to drive the stochastic GA in the early phase of building, no additional codewords can be added to increase the size of the library. To date, little data has been published in the literature on locally optimum edit distance codes of lengths greater than about 12 bases, and this hardware accelerator enables the present invention to efficiently investigate this aspect of the problem domain for the first time.

### EXPERIMENTAL RESULTS

Several hardware accelerator embodiments of the present invention that use a stochastic GA to build DNA codeword libraries of codeword length 16 have been designed, implemented, and tested. The first version uses one fitness evaluator and is implemented on a single FPGA chip.

The design has actually been ported to three different reconfigurable computing platforms, including a Xilinx XUP Virtex-II Pro evaluation board [13], a laptop computer with the Annapolis Wildcard FPGA board [14], and a desktop computer with the Annapolis Wildstar—II FPGA board. Different bus architectures are used to connect the hardware accelerator to the host CPU in each of the different platforms. The PLB bus is used in the Xilinx Virtex-II Pro evaluation board, while the PCMCIA card bus and PCI-X bus are used in the system with WildStar and WildCard, respectively. Another difference among these platforms is the amount of resources available on the FPGA chips resident on the boards.

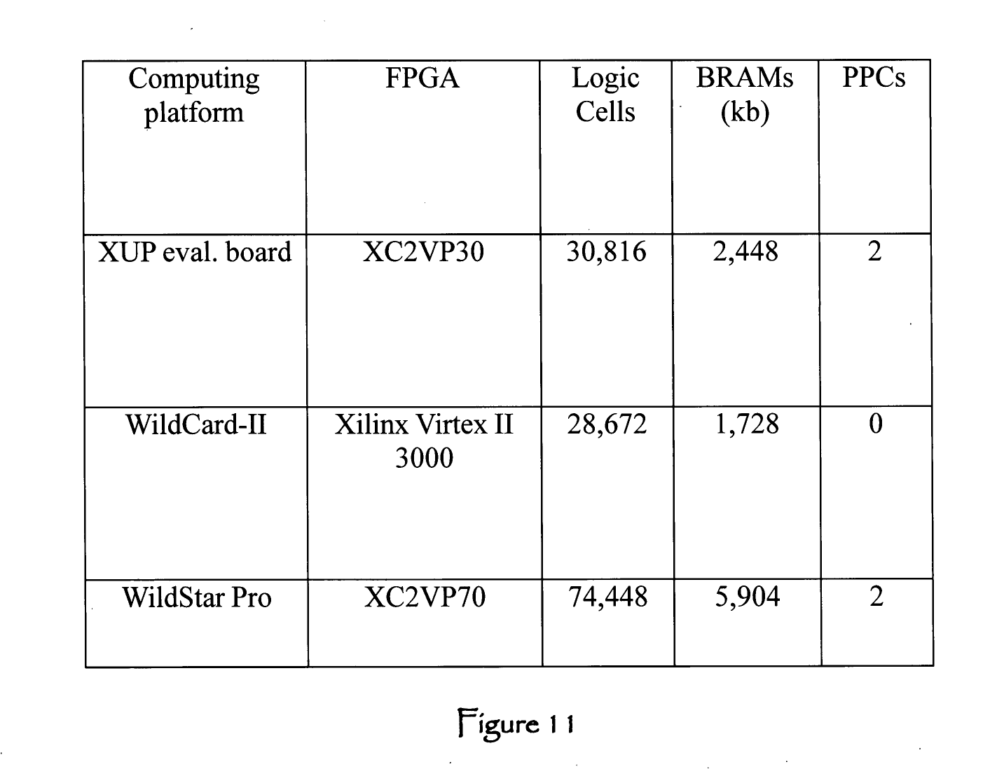

FIG. 11 shows the size of the reconfigurable logic and the on-chip memory for the three different computing platforms. The design is synthesized using Synplify from Synplicity. It uses 12,263 LUTs (look-up-tables), which is about 42% of the programmable resources in a Xilinx Virtex II 3000 FPGA. The hardware accelerator for exhaustive search of DNA codeword length 16 uses 21,733 LUTs, which is about 75% of Virtex II 3000 FPGA.

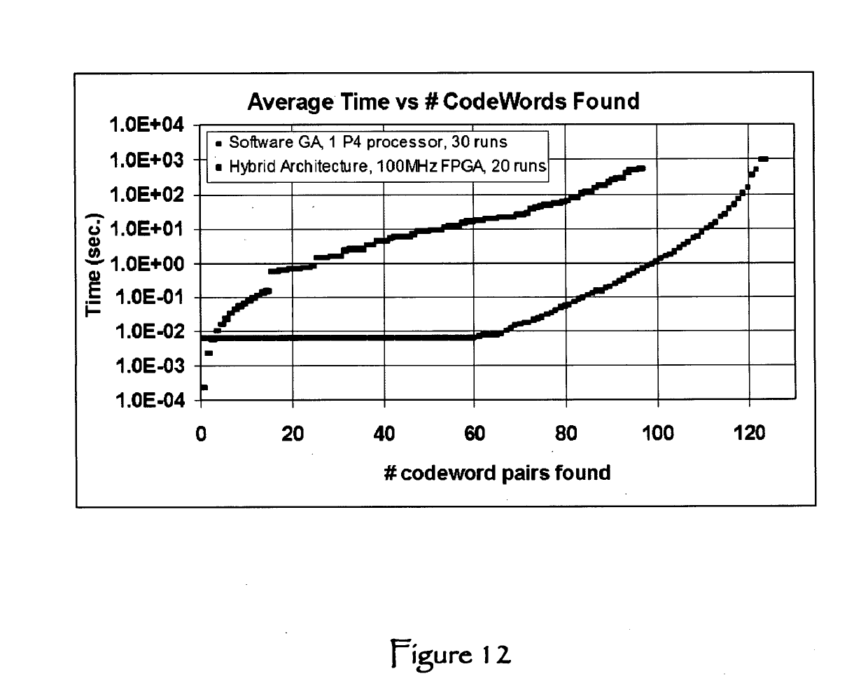

FIG. 12 shows a comparison of the average performance of the GA based codeword search method running in software on a single workstation processor (upper curve) and the hardware accelerated hybrid architecture (lower line). The performance is measured in terms of the time it takes to build a large library. Less time is the preferred result, therefore the lower curve depicts better performance than the upper curve. In this plot the x axis is codewords found, where each codeword consists of a strand and its reverse complement. The GA is stochastic, so each point in the curves is the average over multiple runs of the times taken to find the # of codewords on the x axis. For these experiments we set n and σ to be 16 and 10 respectively. The upper curve for the software version was run on one workstation with 1 P4 processor. The lower curve for the hardware GA was run with a 100 MHz FPGA clock frequency.

Compared to the software only implementation, the hardware accelerator running at 100 MHz provides approximately a 1000× speed-up. The speed-up of the hardware versions is due to the parallel and pipelined architecture of the hardware. If the number of fitness calculating arrays a were increased, a nearly linear speed-up (a/0.98) would be expected. Also, based on previous work [15] that used a distributed Island Model GA run on a cluster of workstations, we would expect linear speed-up as the number of distributed GA populations p is increased.

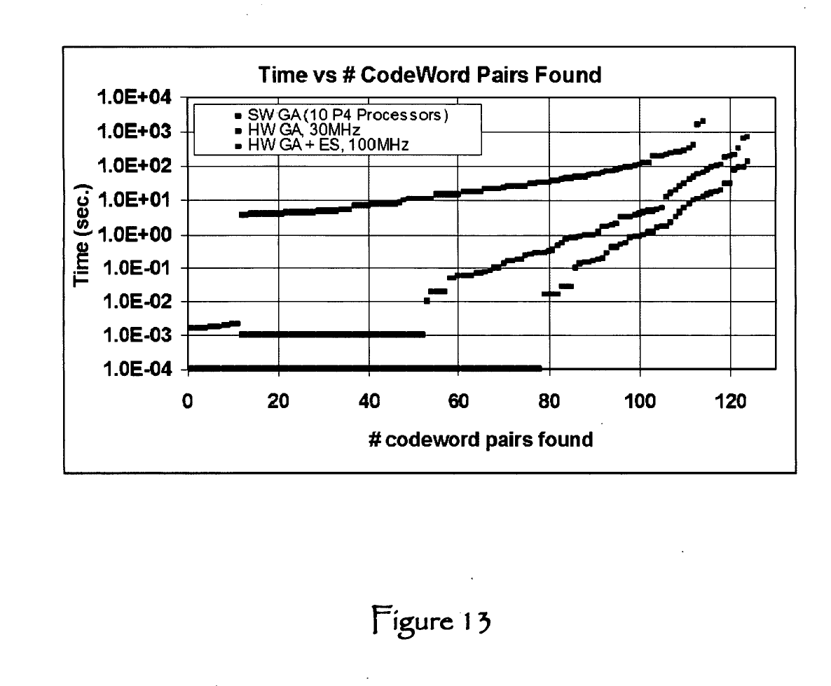

FIG. 13 shows a comparison of the best performance among software-based GA and hardware-based GA. The top curve for the distributed software multi-deme GA was run on a cluster using 10 P4 processors. The interprocessor communication is implemented using MPI (message passing interface). The middle curve for the hardware GA was run on the Annapolis Wildcard-II in a notebook PC with a 30 MHz FPGA clock frequency. The lower curve for the hardware GA with exhaustive search was run on a Wildcard board in a P4 workstation with a 100 MHz FPGA clock frequency. The later run was set up to run the GA until 240 words were found, and then switched to exhaustive search, after which 8 more words were found.

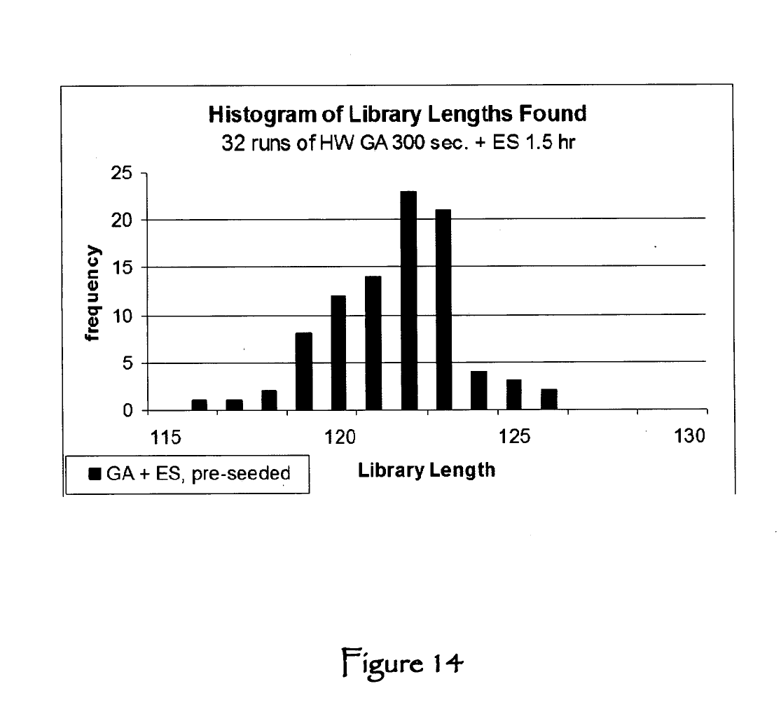

The exhaustive search version of the hardware accelerator was also employed to investigate the average size of locally optimum codeword libraries that can be built, and the efficacy of the GA phase alone for building them. FIG. 14 shows the distribution of the size of the local optimal DNA codeword libraries which are generated by running hardware GA for 300 seconds followed by hardware exhaustive search. The results show that the size of the local optimal DNA codeword library follows a normal distribution with mean of about 122 codewords (word/word' pairs). The experiment consisted of 60 tests, which took about 90 hours. It should be noted that the equivalent test on a 30 workstation cluster would have taken about 3000 hours (4 months).

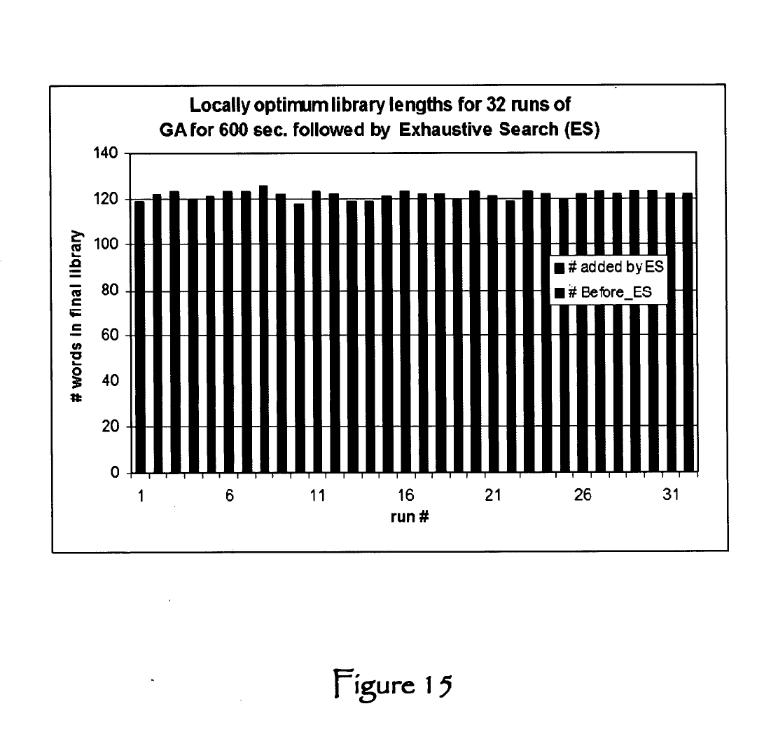

FIG. 15 shows data from a second experiment involving 32 runs of GA for 600 sec. followed by exhaustive search, in terms of the number of words discovered during the initial GA phase and the number of words added by the subsequent exhaustive search phase (the added portion at the top of bar graphs). Averaged across these runs, the GA phase alone finds 120.4 words vs. 121.7 with GA+exhaustive search, or about 98.9% of the words that can be found.

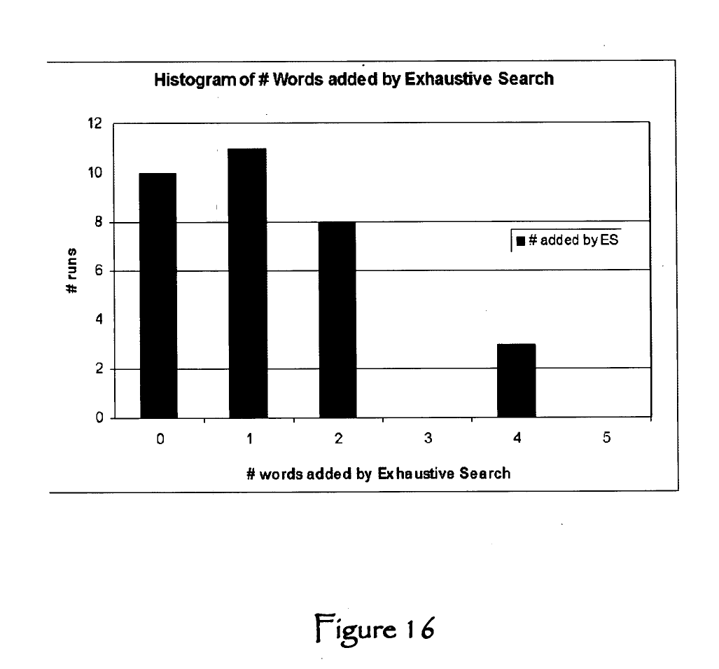

FIG. 16 shows a histogram of the # of words added by exhaustive search for these runs (see FIG. 15). Thus, after the GA phase, exhaustive search of all ˜4.3 billion possible code words finds no additional words in about 30% of the runs, and <5 additional words about 70% of the runs.

While the preferred embodiments have been described and illustrated, it should be understood that various substitutions, equivalents, adaptations and modifications of the invention may be made thereto by those skilled in the art without departing from the spirit and scope of the invention. Accordingly, it is to be understood that the present invention has been described by way of illustration and not limitation.

What is claimed is:

1. An apparatus for accelerating the discovery of DNA codes, comprising:
a computer;
a hardware accelerator; and
a software program stored on a non-transitory computer-readable medium;
wherein said software program comprises computer-executable instructions that, when said computer-readable medium is read by said computer, said instructions are executed by said computer, so as to cause said computer to communicate with said hardware accelerator to act upon a DNA codeword library so as to produce additional DNA codewords.

2. Apparatus of claim 1, wherein said software program further comprises a code generator for producing a nearly locally optimal DNA codeword library, wherein said code generator is based in a genetic algorithm.

3. Apparatus of claim 1, wherein said software program further comprises a code extender for producing a locally optimal DNA codeword library, wherein said code extender employs exhaustive searching.

4. Said software program of claim 1, wherein said instructions further cause said computer and said hardware accelerator to provide the means to:
randomly select a DNA codeword from a population of candidate DNA codewords;
determine the fitness of said selected DNA codeword;
add said selected DNA codeword to a set of good codewords when said fitness equals zero; and
replace said selected DNA codeword with another randomly selected DNA codeword from said DNA codeword library;
continue said random selection, determining, adding and replacing until the occurrence of any one of the events selected from the following group:
the desired number of codewords to be selected is achieved;
a specified time duration has elapsed; or
the maximum number of generations is achieved; and
first, store said codeword values;
second, store the elapsed time at which each said codeword value is found; and
calculate the average time at which the last said codeword value is found across all iterations of said software program.

5. Said apparatus of claim 1, wherein said computer, said hardware accelerator, and said software program interact asynchronously.
